(19) United States
(12) Patent Application Publication
(10) Pub. No.: US 2025/0390889 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Koji TSUKAMOTO, Tokyo (JP); Yoshihisa IJIRI, Tokyo (JP); Hiromu YAMAWAKI, Tokyo (JP); Toshinori MIYOSHI, Tokyo (JP); Takahiro ISHIKAWA, Tokyo (JP)

(21) Appl. No.: 19/072,225

(22) Filed: Mar. 6, 2025

(30) Foreign Application Priority Data
Jun. 20, 2024 (JP) 2024-099959

(51) Int. Cl. G06Q 30/015; G06Q 30/0251; G06Q 30/0601

(52) U.S. Cl. CPC G06Q 30/015; G06Q 30/0257; G06Q 30/0631

(57) ABSTRACT

An information processing apparatus includes an unacquired information determination unit, a target agent identification unit, an inquiry unit, and a providing unit. The unacquired information determination unit determines whether unacquired information is present among pieces of information that are used to provide a service to a user. The target agent identification unit identifies, when the unacquired information determination unit determines that the unacquired information is present, an agent that is estimated to have the unacquired information as a target agent. The inquiry unit makes an inquiry to the target agent that is identified by the target agent identification unit about the unacquired information. The providing unit provides the service to the user by using information that is obtained in response to the inquiry that is made by the inquiry unit.

### CROSS-REFERENCE TO RELATED APPLICATIONS

The present application claims priority to and incorporates by reference the entire contents of Japanese Patent Application No. 2024-099959 filed in Japan on Jun. 20, 2024.

### BACKGROUND OF THE INVENTION

### 1. Field of the Invention

The present invention relates to an information processing apparatus, an information processing method, and an information processing program.

### 2. Description of the Related Art

Conventionally, a service that allows users to exchange messages in a conversation format is known. For example, Japanese Laid-open Patent Publication No. 2022-180282 proposes a technology for receiving an input message that a user has input by utterance, inputting information that includes the input message to generative AI, such as a language model, causing the generative AI to generate a response message, and providing the response message to the user.

However, in the technology as described above, for example, a technology for appropriately acquiring information on the user to improve accuracy of the response message corresponding to the input message of the user is not disclosed, and there is room for improvement in appropriately acquiring information on the user.

### SUMMARY OF THE INVENTION

An information processing apparatus includes an unacquired information determination unit, a target agent identification unit, an inquiry unit, and a providing unit. The unacquired information determination unit determines whether unacquired information is present among pieces of information that are used to provide a service to a user. The target agent identification unit identifies, when the unacquired information determination unit determines that the unacquired information is present, an agent that is estimated to have the unacquired information as a target agent. The inquiry unit makes an inquiry to the target agent that is identified by the target agent identification unit about the unacquired information. The providing unit provides the service to the user by using information that is obtained in response to the inquiry that is made by the inquiry unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to one embodiment;

FIG. 2 is a diagram illustrating an example of a configuration of an information processing system according to one embodiment;

FIG. 3 is a diagram illustrating an example of a configuration of an information processing terminal according to one embodiment;

FIG. 4 is a diagram illustrating an example of a configuration of an inquiry unit in a personal agent processing unit of the information processing terminal according to one embodiment;

FIG. 5 is a diagram illustrating an example of a screen of a chat room that is provided by a providing unit in a processing unit of the information processing terminal according to one embodiment and that is displayed by a display unit;

FIG. 6 is a diagram illustrating an example of a configuration of an inquiry response unit in the personal agent processing unit of the information processing terminal according to one embodiment;

FIG. 7 is a flowchart illustrating an example of information processing that is performed by the personal agent processing unit of the processing unit of the information processing terminal according to one embodiment; and

FIG. 8 is a diagram illustrating an example of a hardware configuration of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. Further, the embodiments may be combined appropriately as long as processing contents do not conflict with each other. Furthermore, in each of the embodiments described below, the same components are denoted by the same reference symbols, and repeated explanation will be omitted.

### 1. One Example of Information Processing

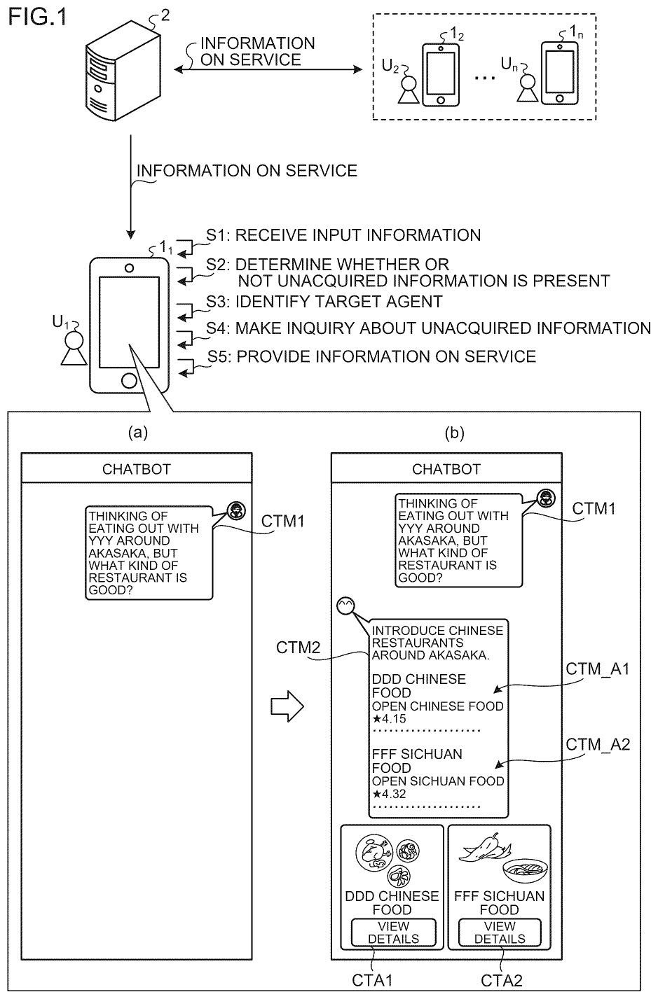

FIG. 1 is a diagram illustrating an example of information processing according to one embodiment, and, in the present embodiment, an information processing apparatus implements an information processing method.

As illustrated in FIG. 1, information processing terminals 1₁, 1₂, . . . , 1ₙ are communicably connected to a service providing apparatus 2, and transmit and receive information to and from the service providing apparatus 2. n is an integer equal to or larger than three. The information processing terminals 1₁, 1₂, . . . , 1ₙ are, for example, smartphones, tablets, mobile Personal Computers (PCs), or the like.

Each of the information processing terminals 1₁, 1₂, . . . , 1ₙ is used by a corresponding user among users U₁, U₂, . . . , Uₙ. For example, the information processing terminal 1₁ is used by the user U₁, the information processing terminal 1₂ is used by the user U₂, and the information processing terminal 1ₙ is used by the user Uₙ.

In the following, when each of the information processing terminals 1₁, 1₂, . . . , 1ₙ is described without being individually distinguished, each of the information processing terminals 1₁, 1₂, . . . , 1ₙ may be described as an information processing terminal 1, and, when each of the users U₁, U₂, . . . , Uₙ is described without being individually distinguished, each of the users U₁, U₂, . . . , Uₙ may be described as a user U.

The service providing apparatus 2 provides various kinds of services to the user U of the information processing terminal 1. The service providing apparatus 2 provides an online service, such as a chat service, various kinds of search services, various kinds of reservation services, an advertisement distribution service, a map information providing service, an electronic commerce service, a service information providing service, or a profile providing service.

The service providing apparatus 2 provides, for example, an Application Programming Interface (API), and the information processing terminal 1 able to transmit and receive various kinds of information on various kinds of online services that are provided by the service providing apparatus 2 via the API.

In the example illustrated in FIG. 1, in the chat service that is provided by the service providing apparatus 2, a chat group of a group A is formed for the plurality of users U₁, U₂, . . . , Uₙ, and the plurality of users U₁, U₂, . . . , Uₙ are able to exchange message in a chat room of the group A.

An application of an instant messenger (hereinafter, may be described as a chat application) for performing a group chat is installed in each of the information processing terminals 1. In the chat application, it is possible to transmit and receive a message in a one-to-one chat, transmit and receive a message in the group chat, transmit and receive a message in a one-to-many chat, or the like. Transmission and reception of a message in the one-to-one chat include transmission and reception of a message between a chatbot and the user U.

The information processing terminal 1 is one example of an information processing apparatus. In the following, a process performed by the information processing terminal 1₁ will be explained, but the information processing terminals 1₂, . . . , 1ₙ other than the information processing terminal 1₁ are able to perform the same process.

The information processing terminal 1₁ receives, as input information, information that is input by the user U₁ (Step S1). The input information includes, for example, information related to a service. The information related to a service is information related to a service that is provided by the service providing apparatus 2, but may be information related to a service that is provided by a service providing apparatus other than the service providing apparatus 2.

The information processing terminal 1₁ determines, based on the input information that is received at Step S1, whether or not unacquired information is present among pieces of information that are used to provide a service to the user U₁ (Step S2). The information that is used to provide a service to the user U₁ may include information related to the user U₁, information related to a different user U, or the like.

The information processing terminal 1₁ identifies a type of the service and values of one or more parameters among a plurality of parameters that are used to provide the service of the type, based on the input information that is received at Step S1. In the following, the type of the service may be described as a service type.

The plurality of parameters that are used to provide the service include a mandatory parameter that is a parameter needed to provide the service and an additional parameter that is a parameter for increasing accuracy of service provision.

When the service type is a product search service, the mandatory parameter is, for example, a type of a product, a name of the product, or the like, and the additional parameter is a parameter other than the mandatory parameter, such as a price range, a model name, a color, evaluation, display order, or a maximum number of acquisitions, but embodiments are not limited to this example.

When the service type is a restaurant search service, the mandatory parameter is, for example, at least one of an area of a restaurant and a genre of food, and the additional parameter is a parameter other than the mandatory parameter, such as a price range, a seat (terrace, table, tatami room), facilities (wheelchair, pets allowed), evaluation, allergic ingredients, display order, or a maximum number of acquisitions, but embodiments are not limited to this example.

Furthermore, when the service type is a hotel search service, the mandatory parameter is, for example, at least one of an area of a hotel, scheduled date and time of stay, the number of people, or the like, the additional parameter is a parameter other than the mandatory parameter, such as the number of rooms, the number of adults, the number of children, evaluation, a price range, facilities/services (wifi, Japanese-style room/Western-style room, double bed, single bed, no smoking/smoking), display order, or a maximum number of acquisitions, but embodiments are not limited to this example.

At Step S2, the information processing terminal 1₁ inputs, to generative Artificial Intelligence (AI), information that includes the input information received at Step S1 and information for instructing identification of a service type and values of a plurality of parameters, and acquires the service type and the values of the parameters that are identified by the generative AI.

The generative AI is, for example, text generative AI. The text the generative AI is, for example, Large Language Models that are trained to estimate and output a next token from an input token string, and is, for example, a transformer-based model, a Recurrent Neural Network (RNN)-based model, or the like. Examples of the transformer-based model include a Generative Pre-trained Transformer (GPT), but embodiments are not limited to this example. Examples of the RNN-based model include a Receptance Weighted Key Value (RWKV), but embodiments are not limited to this example.

Meanwhile, the generative AI may be a language model that is trained (for example, fine-tuning) exclusively for generating answer information. The generative AI is arranged in an external information processing apparatus, and the information processing terminal 1₁ uses the generative AI via an API; however, the generative AI may be arranged in the information processing terminal 1₁.

The information processing terminal 1₁ is able to input, to the generative AI, information that includes the input information that is input by the user U₁ and the instruction information, and cause the generative AI to output a service type and values of one or more parameters. The instruction information is for instructing the generative AI to identify a service type and values of one or more parameters that are used to provide a service of the service type from the input information that is input by the user U₁.

The instruction information is, for example, a character string of” includes, for example, information on a character string of “Please identify a type of a service and a value of a parameter that is used to provide the service of this type from given information. Please identify the type of the service from a service type list below, and identify the value of the parameter from a parameter list below. Please output an identification result in an output format below.” and information on the service type list, the parameter list, and the output format.

The service type list includes, for example, information in which a service type and information indicating a content of a service are associated with each other for each of service types. The parameter list includes, for each of the service types, information in which a parameter and information indicating a content of the parameter are associated with each other for each of parameters, for example. Meanwhile, the instruction information is not limited to the example as described above, and may be any information as long as it is possible to output a type of a service and a value of a parameter that is used to provide the service of this type from the input information that is input by the user U₁.

Furthermore, when the generative AI is a GPT that is provide by OpenAI, it is possible to cause the generative AI to output the service type and values of one or more parameters by using a function calling function. In this case, information that is input to the generative AI includes, for each of the service types, information that indicates a definition of a service type, information that indicates a definition of each parameter, or the like.

Moreover, when the generative AI is fine-tuned so as to output a type of the service and a value of a parameter that is used to provide the service of this type from the input information that is input by the user U₁, the input information that is input to the generative AI need not always include the instruction information.

Furthermore, the information processing terminal 1₁ may be configured to identify the type of the service and the value of the parameter that is used to provide the service of this type from the input information that is input by the user U₁ by a well-known slot filling technology without using the generative AI.

The information processing terminal 1₁ identifies, as unacquired information, a parameter for which a value is not yet identified among the plurality of parameters that are identified as described above. The information processing terminal 1₁ stores therein, for each of the services, the service type and the plurality of parameters in an associated manner, and identifies the plurality of parameters that are associated with the service type that is identified as described above.

The plurality of parameters include the mandatory parameter and the additional parameter, but one of the mandatory parameter and the additional parameter need not always be included in the parameters. The information processing terminal 1₁ identifies a plurality of parameters that are associated with the service type that is identified at Step S3 from among the stored service types of the respective services and the plurality of parameters for each of the service types.

Further, the information processing terminal 1₁ identifies, as an unidentified parameter, a mandatory parameter for which a value is not yet identified among the plurality of parameters that are associated with the identified service type. Furthermore, the information processing terminal 1₁ may identify, as an unidentified parameter, an additional parameter for which a value is not yet identified among the plurality of parameters, in addition to the mandatory parameter for which the value is not yet identified.

Moreover, when the instruction information is set such that the generative AI outputs information on a parameter for which a value is not yet identified, the information processing terminal 1₁ may identify an unidentified parameter from among the plurality of parameters that are associated with the identified service type based on the information that is output from the generative AI.

When determining that the unacquired information is present at Step S3, the information processing terminal 1₁ identifies, as a target agent, an agent that is estimated to have the unacquired information (Step S3). The agent that is estimated to have the unacquired information is an agent that is estimated to be able to provide the unacquired information.

When, for example, the unacquired information is a profile of the user U₁, the information processing terminal 1₁ estimates, as a service agent that includes the unacquired information, an agent of a profile providing service that provides the profile of the user U₁ among a plurality of service agents that provide respective services. The profile of the user U₁ includes, for example, information on an attribute of the user U₁, on the user U₁, or the like.

Furthermore, when for example, the unacquired information is a service history of the user U₁ in a specific service, the information processing terminal 1₁ estimates, as the service agent that includes the unacquired information, an agent of a specific service among the plurality of service agents that provide services. Examples of the specific service include the restaurant search service and the hotel search service, but embodiments are not limited to this example.

Moreover, when the unacquired information is API information of a target service type, the information processing terminal 1₁ estimates, as the service agent that includes the unacquired information, an agent of a service information providing service that provides API information on various kinds of services among the plurality of service agents that provide services.

Furthermore, when the unacquired information is information on a different user U other than the user U₁, the information processing terminal 1₁ identifies, as the target agent, a certain personal agent that is a personal agent of the different user U and that is estimated to have the unacquired information.

For example, the information processing terminal 1₁ identifies, as the target agent, one or more personal agents among personal agents of the different user U₂ and a different user Uₙ among personal agents of the different users U₂ and Uₙ in a chat room of a group A that is set for the plurality of users U₁, U₂, and Uₙ including the user U₁ and the different users U₂ and Uₙ.

Each of the information processing terminals 1₁, 1₂, . . . , 1ₙ includes a corresponding personal agent PA among a plurality of personal agents PA₁, PA₂, . . . , PAₙ. In the following, when each of the personal agents PA₁, PA₂, . . . , PAₙ is described without being individually distinguished, each of the personal agents PA₁, PA₂, . . . , PAₙ may be described as the personal agent PA. The personal agent PA is a service agent for each of the users U, and may be, for example, Auto-GPT or the like.

The personal agent P functions as an agent for the user U. For example, the personal agent PA₁ functions as an agent for the user U₁, the personal agent PA₂ functions as an agent for the user U₂, and the personal agent PAₘ functions as an agent for the user Um. The processes from Step S1 to Step S5 illustrated in FIG. 1 are performed by the personal agent PA₁.

For example, it is assumed that the input information that is received at Step S1 is information on a character string of “thinking of giving a chocolate to XXX on Valentine's Day, but what kind of chocolate does XXX like?”, and “XXX” is the user U₂.

In this case, the information processing terminal 1₁ identifies the personal agent PA₂ of the user U₂ as the target agent. Furthermore, in this case, the service type that is identified at Step S2 is a “product search service” and the type of the unacquired information that is determined at Step S3 is a “type of chocolate”.

Moreover, it is assumed that the input information that is received at Step S1 is information on a character string of “thinking of eating out with YYY around Akasaka, but what kind of restaurant is good?” like a message CTM1 as illustrated in (a) in FIG. 1, and “YYY” is the user Uₙ.

In this case, the information processing terminal 1₁ identifies the personal agent PAₙ of the user Uₙ as the target agent. Furthermore, in this case, the service type that is identified at Step S2 is a “restaurant search service”, the parameter for which the value is identified at Step S2 is “around Akasaka”, and the type of the unacquired information that is determined at Step S3 is a “genre of food”.

Moreover, when the input information that is received at Step S1 is a message that is posted in the chat room of the group A, the information processing terminal 1₁ is able to identify, as target agents, the personal agents PA of the different user U₂, . . . , Uₙ or one or more the different users U in the chat room of the group A.

The information processing terminal 1₁ makes an inquiry to the target agent that is identified at Step S3 about the unacquired information that is determined at Step S3 (Step S4).

For example, at Step S4, the information processing terminal 1₁ generates a request sentence that is a sentence for requesting the target agent that is identified at Step S2 to notify the unacquired information that is identified at Step S3. Further, the information processing terminal 1₁ inquires the unacquired information that is determined at Step S3, by using the generated request sentence.

For example, the information processing terminal 1₁ inputs, as input information, information that includes the type of the unacquired information and the instruction information to the generative AI, and causes the generative AI to generate the request sentence. The type of the unacquired information is, for example, a type of an unidentified parameter, but embodiments are not limited to this example. Furthermore, the instruction information is, for example, information of “Please generate a sentence for making an inquiry to an agent about given information”, but embodiments are not limited to this example.

For example, when the type of the unacquired information is a service usage history of the user U₁ with respect to the restaurant search service and is information that is obtained from a service agent of the restaurant search service, the request sentence is a sentence for acquiring the service usage history and is a sentence in the JavaScript (registered trademark) Object Notation (JSON) format, for example. Furthermore, when the service agent is able to interpret a sentence in a natural language by using the generative AI or the like, the request sentence may be, for example, information on a character string of “Please output the service usage history of the user U₁.”, but embodiments are not limited to this example.

Furthermore, when the type of the unacquired information is the profile of the user U₁ and is information that is obtained from a service agent of the profile providing service, the request sentence is a sentence for acquiring the profile of the user U₁ and is a sentence in the JSON format, for example. Moreover, when the service agent is able to interpret a sentence in a natural language by using the generative AI or the like, the request sentence may be, for example, information on a character string of “Please output the profile of the user U₁.”, but embodiments are not limited to this example.

When, for example, the type of the unacquired information is information that indicates the type of chocolate and an inquiry destination is the personal agent PA₂, the request sentence may be information on a character string of “Please tell me a type of chocolate that is loved by XXX.”, but embodiments are not limited to this example.

Moreover, when, for example, the type of the unacquired information is a genre of food and an inquiry destination is the personal agent PAₙ, the request sentence may be information on a character string of “Please tell me a genre of food that is loved by XXX.”, but embodiments are not limited to this example.

The information processing terminal 1₁ is able to generate a message that is to be posted in the chat room of the group A that is set for the plurality of users U₁ and that is for inquiring pieces of unacquired information U₂, . . . , Uₙ. Furthermore, the information processing terminal 1₁ may post the generated message to the chat room of the group A to make an inquiry to the personal agent PA that is the target agent PA about the unacquired information.

When, for example, a hidden mode that is setting of a hidden state is set, the information processing terminal 1₁ is able to make an inquiry to the personal agent PA that is the target agent PA about the unacquired information. In this case, the message for inquiring the unacquired information is not displayed in the chat room of the group A. Further, when the hidden mode is set in the personal agent PA serving as the target agent PA, the message for inquiring the unacquired information is not displayed in the chat room of the group A.

Here, it is assumed that the target agent to which an inquiry about the unacquired information is made is the personal agent PA₂ off the user U₂. In this case, the personal agent PA₂ receives an inquiry about the unacquired information from the personal agent PA₁. The personal agent PA₂ determines whether or not to provide the unacquired information in response to the received inquiry.

The personal agent PA₂ has, for example, provision possibility information that indicates possibility of provision for each type of unacquired information, and determines whether or not it is possible to provide the unacquired information based on the provision possibility information. The provision possibility information is set by, for example, the user U₂.

The personal agent PA₂ determines that the unacquired information is to be provided when the provision possibility information has setting indicating that provision of the unacquired information is possible, and determines that the unacquired information is not to be provided in other cases.

Furthermore, the personal agent PA₂ may have, for example, inquiry necessity information that indicates necessity of an inquiry to the user U₂ for each type of the unacquired information. The inquiry necessity information is set by, for example, the user U₂. When the type of the unacquired information (for example, the type of the unidentified parameter) is a certain type for which an inquiry to the user U₂ is needed, the personal agent PA₂ displays, in a pop-up manner, an inquiry message for inquiring if it is allowed to provide the unacquired information to the user U₂, in a display area of the information processing terminal 1₂.

When the user U₂ inputs positive information (for example, information on a character string of “Yes”, information on a character string of “OK”, or the like) in response to the inquiry message that is displayed in a pop-up manner, the personal agent PA₂ outputs the unacquired information to the personal agent PA₁.

The information processing terminal 1₂ stores therein, for example, information on the user U₂, such as attribute information on the user U₂ or information indicating a behavior history of the user U₂, and the personal agent PA₂ extracts, as the unacquired information, information that corresponds to the inquiry from the information on the user U₂. Further, the personal agent PA₂ provides, to the personal agent PA₁, the unacquired information that is determined to be provided.

For example, when the type of the unacquired information is a type of chocolate that is loved by the user U₂ and the user U₂ loves bitter chocolates, the personal agent PA₂ outputs information on a character string of “bitter chocolates” or a character string of “XXX loves bitter chocolates.” as the unacquired information.

Furthermore, when the target agent to which the inquiry about the unacquired information is made is the personal agent PAₙ of the user Uₙ, the same process as the process that is performed by the personal agent PA₂ of the user U₂ is performed. For example, when the type of the unacquired information is a genre of food that is loved by the user Uₙ and the user Uₙ loves Chinese food, the personal agent PAₙ outputs, as the unacquired information, information on a character string of “Chinese food” or a character string of “YYY loves Chinese food.”.

When the information processing terminal 1₁ posts the inquiry message that is a message for inquiring the unacquired information in the chat room of the group A, the information processing terminal 1₁ is able to display the inquiry message and the unacquired information that is output by the personal agent PA of the different user U in response to the inquiry message. The unacquired information is one example of information that indicates a content of a response.

Moreover, when the hidden mode that is setting of a hidden state is set, the information processing terminal 1₁ does not display the inquiry message and the unacquired information in the chat room of the group A. The setting of the hidden mode in the information processing terminal 1₁ is made by the user U₁, the setting of the hidden mode in the information processing terminal 1₂ is made by the user U₂, and the setting of the hidden mode in the information processing terminal 1ₙ is made by the user Uₙ.

The information processing terminal 1₁ provides a service to the user U by using information that is provided by the target agent in response to the inquiry that is made at Step S4 (Step S5). For example, the information processing terminal 1₁ acquires information on a service of the service type that is identified at Step S2 based on the service type that is identified at Step S2 and the information that is provided by the target agent in response to the inquiry that is made at Step S4.

For example, when the service type that is identified at Step S2 is the product search service, the information processing terminal 1₁ designates the product search service and transmits a search request that includes information indicating a type of a product as the information on the parameter to the service providing apparatus 2 via the API of the service providing apparatus 2.

The service providing apparatus 2 searches for a plurality of products in accordance with a search request, and provides a search result as information on the service of the service type that is identified at Step S2 to the information processing terminal 1₁. The search result includes, for example, information, such as a name, a price, evaluation, or an introduction text, of each of the retrieved products, but embodiments are not limited to this example.

For example, when the service type that is identified at Step S2 is the restaurant search service, the information processing terminal 1₁ designates the restaurant search service, and transmits a search request that includes information indicating a genre of food as the information on the parameter to the service providing apparatus 2 via the API of the service providing apparatus 2.

The service providing apparatus 2 searches for a plurality of restaurants in accordance with the search request, and provides a search result, as the information on the service of the service type that is identified at Step S2, to the information processing terminal 1₁. The search result includes, for example, information on a name, a place, evaluation, an introduction text, or the like of each of the retrieved restaurants, but embodiments are not limited to this example.

In the example illustrated in (b) in FIG. 1, in the chat room in the information processing terminal 1₁, restaurant information CTA1, restaurant information CTA2, restaurant information CTM_A1, and restaurant information CTM_A2 are displayed as service information. The restaurant information CTA1 and the restaurant information CTM_A1 are pieces of information on DDD Chinese food, and the restaurant information CTA2 and the restaurant information CTM_A2 are pieces of information on FFF Sichuan food.

The restaurant information CTM_A1 and the restaurant information CTM_A2 are pieces of information in message formats, and included in a chat message CTM2. The restaurant information CTM_A1 and the restaurant information CTM_A2 are displayed in the same display mode as the display mode of the chat message in the screen of the group chat. The restaurant information CTA1 and the restaurant information CTA2 are pieces of information in a banner format that includes an image, text, and a link.

In this manner, the information processing terminal 1 determines whether or not the unacquired information is present among pieces of information that are used to provide a service to the user U, and identifies an agent that is estimated to have the unacquired information as the target agent. Further, the information processing terminal 1 makes an inquiry to the target agent about the unacquired information, and provides the service to the user U by using information that is provided by the target agent in response to the inquiry that is made by the inquiry unit. With this configuration, the information processing terminal 1 is able to appropriately acquire information on the user U and provide a service.

A configuration of the information processing system that includes the information processing terminals 1₁, 1₂, . . . , 1ₙ and the service providing apparatus 2 that perform the above-described process will be described in detail below.

### 2. Configuration of Information Processing System

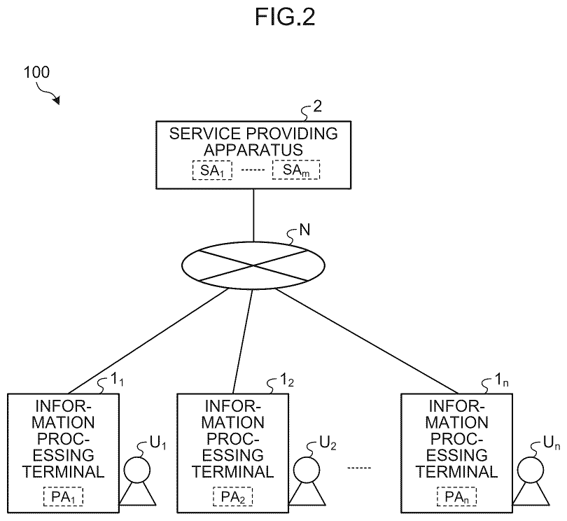

FIG. 2 is a diagram illustrating an example of a configuration of an information processing system according to one embodiment. As illustrated in FIG. 2, an information processing system 100 according to one embodiment includes the information processing terminals 1₁, . . . , 1ₙ and the service providing apparatus 2.

The plurality of information processing terminals 1 are used by different users U. Each of the information processing terminals 1 is, for example, a smartphone, a tablet PC, a notebook PC, a desktop PC, or the like, but embodiments are not limited to this example.

The information processing terminals 1 and the service providing apparatus 2 are communicably connected to one another in a wired or wireless manner via the network N. Meanwhile, the information processing system 100 illustrated in FIG. 2 may include the plurality of service providing apparatuses 2.

The network N includes, for example, a Wide Area Network, such as the Internet, a mobile communication network, such as Long Term Evolution (LTE), 4th Generation Mobile Communication System (4G), or 5th Generation Mobile Communication System (5G).

Each of the information processing terminals 1 is able to connect to the network N via a near field wireless communication, such as a mobile communication network, Bluetooth (registered trademark), or a wireless Local Area Network (LAN), and communicate with the service providing apparatus 2.

### 3. Configuration of Information Processing Terminal 1

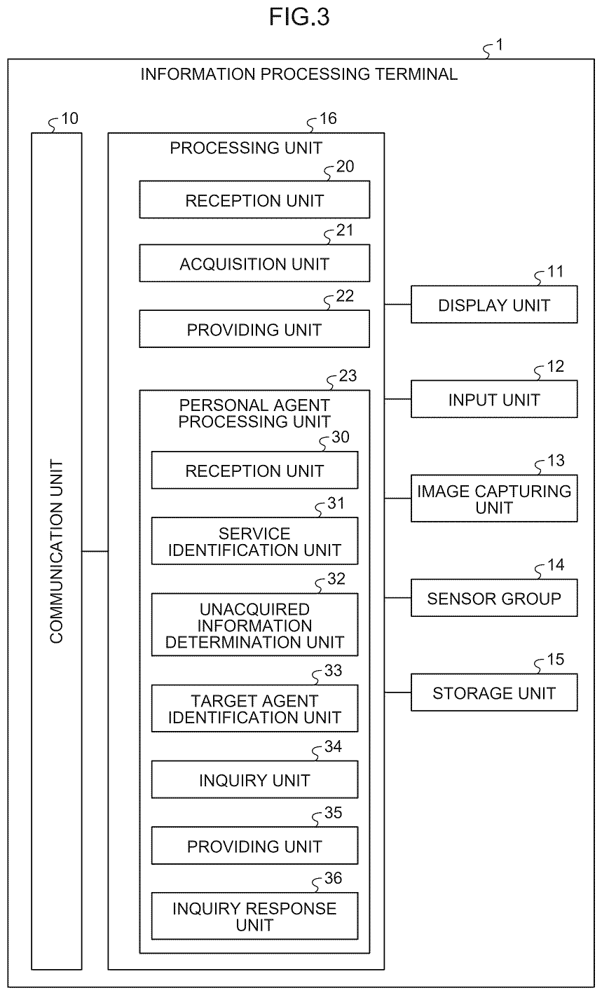

FIG. 3 is a diagram illustrating an example of a configuration of the information processing terminal 1 according to one embodiment. As illustrated in FIG. 3, the information processing terminal 1 includes a communication unit 10, a display unit 11, an input unit 12, an image capturing unit 13, a sensor group 14, a storage unit 15, and a processing unit 16. Meanwhile, the information processing terminal 1 may include a speaker or the like (not illustrated).

### 3.1. Communication Unit 10

The communication unit 10 is implemented by, for example, a communication module, a Network Interface Card (NIC), or the like. Further, the communication unit 10 is connected to the network N in a wired or wireless manner and transmits and receives information to and from the service providing apparatus 2 via the network N.

### 3.2. Display Unit 11

The display unit 11 is, for example, a Liquid Crystal Display (LCD), an organic Electro Luminescence (EL), or the like.

### 3.3. Input Unit 12

The input unit 12 includes, for example, a keyboard that includes keys, an enter key, arrow keys, and the like for inputting characters, numerals, or a space, a mouse, a power button, or the like. When the display unit 11 is a touch screen display, the input unit 12 includes a touch panel.

### 3.4. Image Capturing Unit 13

The image capturing unit 13 is an image sensor (camera) that captures an image of an object. For example, the image capturing unit 13 may be a Complementary Metal Oxide Semiconductor (CMOS) image sensor, a Charge-Coupled Device (CCD) image sensor, or the like. Meanwhile, the image capturing unit 13 is not limited to a built-in camera, but may be an external cameral, such as a wireless camera or a Web camera, that is able to perform communication with the communication unit 10.

### 3.5. Sensor Group 14

The sensor group 14 includes, for example, a ranging sensor, a microphone, an acceleration sensor, a gyro sensor, or the like. The ranging sensor is a location sensor that detects a location of the information processing terminal 1. The microphone is a sensor that detects sound around the information processing terminal 1. The acceleration sensor is a sensor that detects acceleration of the information processing terminal 1. The gyro sensor is a sensor that detects a posture, such as inclination or rotation, of the information processing terminal 1.

### 3.6. Storage Unit 15

The storage unit 15 is implemented by, for example, a semiconductor memory device, such as a Random Access Memory (RAM) or a Flash Memory, or a storage device, such as a hard disk or an optical disk.

The storage unit 15 stores therein, for example, information that is transmitted by the service providing apparatus 2 and that is acquired by the processing unit 16 via the network N and the communication unit 10, detection information that is information detected by the sensor group 14, or the like.

Furthermore, the storage unit 15 stores therein, for each of services, a service type and a plurality of parameters in an associated manner. The plurality of parameters include the mandatory parameter and the additional parameter. The mandatory parameter is a parameter that is needed to provide a service. The additional parameter is a parameter for increasing accuracy of service provision.

Moreover, the storage unit 15 stores therein setting information. The setting information includes availability information as information that indicates availability of each of parameters for each type of information, and inquiry necessity information that indicates necessity of an inquiry for each type of information. The setting information further includes attribute information that indicates an attribute of the user U.

Furthermore, the storage unit 15 stores therein user information that is information on the user U. The user information is the attribute information on the user U, information indicating a behavior history of the user U, or the like, but embodiments are not limited to this example.

Examples of the attribute information on the user U attribute information include information on a psychographic attribute and information on a demographic attribute. Examples of the demographic attribute include gender, an age, a place of residence, and an occupation, and examples of the psychographic attribute include interests, such as travel, cloths, vehicles, or a religion, a lifestyle, thought, and a tendency of thought.

The behavior history of the user U is a behavior history of the user U in an online service and a behavior of the user in an offline environment. The behavior history of the user U in the online service includes, for example, information on a search history, a browsing history, a post history, a purchase history, or the like.

The search history is information on a search query that was used by the user U in the past and a content that was viewed by the user U from among search results. The information on the search query is, for example, information on a search keyword, a search phrase, or the like.

The browsing history includes, for example, information that indicates a content that is viewed by the user U in the online service, and the post history includes, for example, information that indicates a content (for example, a review, a comment, or the like) that was posted in the past by the user U in the online service, information on a chat message that was posted by the user U in the past in the chat service, or the like. The purchase history includes information on a business counterparty with whom the user U made a deal in the past.

The behavior history of the user U in an offline environment includes, for example, a movement history of the user U in an offline environment, a usage history (including a purchase history of a product or a service) of the user U in a real store, or the like, but embodiments are not limited to this example.

### 3.7. Processing Unit 16

The processing unit 16 is a controller, and implemented by, for example, causing a processor, such as a Central Processing Unit (CPU) or a Micro Processing Unit (MPU), to execute various kinds of programs (corresponding to one example of an information processing program) that are stored in a storage device in the information processing terminal 1 by using a RAM or the like as a work area.

All or a part of the processing unit 16 may be implemented by, for example, an integrated circuit, such as an Application Specific Integrated Circuit (ASIC) or a Field Programmable Gate Array (FPGA). An information processing program is installed, as a dedicated application program (for example, including a chat application) that operates on an Operating System (OS) is installed in the processing unit 16, and enables the processing unit 16 to function as a function unit that include a reception unit 20, an acquisition unit 21, a providing unit 22, and a personal agent processing unit 23. The personal agent is a service agent for each of users, and may be, for example, Auto-GPT or the like.

### 3.7.1. Reception Unit 20

The reception unit 20 receives various kinds of information. For example, the reception unit 20 receives, as input information, information that is input in accordance with input operation that is performed by the user U. For example, the reception unit 20 receives, as the input information, a chat message that is input in the chat room by the user U.

### 3.7.2. Acquisition Unit 21

The acquisition unit 21 acquires various kinds of information from the service providing apparatus 2, the storage unit 15, or the like. For example, the acquisition unit 21 acquires post information that is provided by the service providing apparatus 2 and that includes a chat message of the different user U.

### 3.7.3. Providing Unit 22

The providing unit 22 provides various kinds of information. For example, the providing unit 22 causes the display unit 11 to display various kinds of information and provides the various kinds of information to the user U.

The providing unit 22 adds the chat message that is received by the reception unit 20 to the chat room that is displayed on the display unit 11, and provides the chat message that is received by the reception unit 20 such that the user U can recognize the chat message.

Furthermore, the providing unit 22 adds a chat message that is acquired by the acquisition unit 21 from the service providing apparatus 2 or the like to the chat room that is displayed on the display unit 11, and provides the chat message that is acquired by the acquisition unit 21 such that the user U can recognize the chat message.

### 3.7.4. Personal Agent Processing Unit 23

The personal agent processing unit 23 implements the functions of the personal agent PA as described above. The personal agent processing unit 23 includes a reception unit 30, a service identification unit 31, an unacquired information determination unit 32, a target agent identification unit 33, an inquiry unit 34, a providing unit 35, and an inquiry response unit 36.

### 3.7.4.1. Reception Unit 30

The reception unit 30 receives the input information from the user U. For example, the reception unit 30 receives the input information that is received by the reception unit 20.

The input information includes, for example, information related to a service, information on the different user U, or the like. The information related to the service is information related to a service that is provided by the service providing apparatus 2, but may be information related to a service that is provided by a different service providing apparatus from the service providing apparatus 2.

### 3.7.4.2. Service Identification Unit 31

The service identification unit 31 identifies a service type and values of one or more parameters among a plurality of parameters that are used to provide a service of the subject service type, based on the input information that is received by the reception unit 30.

The service identification unit 31 inputs, to the generative AI, information that includes the input information that is received by the reception unit 30 and information for instructing identification of a service type and values of a plurality of parameters, and acquires the service type and the values of the parameters that are identified by the generative AI.

The generative AI is, for example, text generative AI. The text the generative AI is, for example, Large Language Models that are trained to estimate and output a next token from an input token string, and is, for example, a transformer-based model, an RNN-based model, or the like.

Examples of the transformer-based model include a GPT, but embodiments are not limited to this example. Examples of the RNN-based model include a RWKV, but embodiments are not limited to this example. The generative AI is arranged in an external information processing apparatus, and the service identification unit 31 uses the generative AI via an API; however, the generative AI may be arranged in the information processing terminal 1.

The service identification unit 31 is able to input, to the generative AI, information that includes the input information, which is input by the user U and which is received by the reception unit 30, and the instruction information, and cause the generative AI to output the service type and a value of a parameter. The service identification unit 31 identifies the service type and the value of the parameter based on the information that indicates the service type and the value of the parameter and that is output by the generative AI. The instruction information is information for instructing the generative AI to identify the service type and the value of the parameter that is used to provide a service of the identified service type from the input information that is received by the reception unit 30.

The instruction information includes, for example, information on a character string of “Please identify a type of a service and a value of a parameter that is used to provide the service of this type from given information. Please identify the type of the service from a service type list below, and identify the value of the parameter from a parameter list below. Please output an identification result in an output format below.”, and information on the service type list, the parameter list, and the output format.

The service type list includes, for example, information in which a service type and information indicating a content of a service are associated with each other for each of service types. The parameter list includes, for each of the service types, information in which a parameter and information indicating a content of the parameter are associated with each other for each of parameters, for example. Meanwhile, the instruction information is not limited to the example as described above, and may be any information as long as it is possible to output a type of a service and a value of a parameter that is used to provide the service of this type from the input information that is received by the reception unit 30.

Furthermore, when the generative AI is a GPT that is provide by OpenAI, it is possible to cause the generative AI to output the service type and values of one or more parameters by using a function calling function. In this case, information that is input to the generative AI includes, for each of the service types, information that indicates a definition of a service type, information that indicates a definition of each parameter, or the like.

Moreover, when the generative AI is fine-tuned so as to output the type of the service and the value of the parameter that is used to provide the service of this type from the input information that is received by the reception unit 30, the input information that is input to the generative AI need not always include the instruction information.

Furthermore, the service identification unit 31 may be configured to identify the type of the service and the value of the parameter that is used to provide the service of this type from the input information that is received by the reception unit 30 by a well-known slot filling technology without using the generative AI.

Meanwhile, it is assumed that the input information that is received by the reception unit 30 is a chat message that is posted by the user U in the chat room of a chat group to which the user U belongs. In this case, the unacquired information determination unit 32 may identify the value of the parameter by using the generative AI based on the chat message that is received by the reception unit 30 and a chat message group that includes other chat messages that are posted in the same chat room, for example. The other chat messages are, for example, messages that are posted before a predetermined period, but embodiments are not limited to this example.

Moreover, when it is difficult to identify the service type by using the generative AI, the service identification unit 31 does not identify the value of the parameter or identifies a value of a parameter for which the value is identifiable, but embodiments are not limited to this example.

### 3.7.4.3. Unacquired Information Determination Unit 32

The unacquired information determination unit 32 determines whether or not the unacquired information is present among pieces of information that are used to provide a service to the user U.

The unacquired information determination unit 32 determines, as the unacquired information, for example, information on an unidentified parameter that is a parameter for which a value is not yet identified among the plurality of parameters that are identified by the service identification unit 31. The information on the unidentified parameter that is determined as the unacquired information is information that indicates the unidentified parameter, but may be any information as long as it is possible to identify the unidentified parameter.

When a plurality of unidentified parameters are present, the unacquired information determination unit 32 may identify information on one or more unidentified parameters among the plurality of unidentified parameters as unidentified information, based on the input information that is received by the reception unit 30.

For example, when the input information that is received by the reception unit 30 is information on a character string of “thinking of giving a chocolate to XXX on Valentine's Day, but what kind of chocolate does XXX like?” and when the “type of chocolate” is not identified, the unacquired information determination unit 32 determines the “type of chocolate” as the unidentified information. Furthermore, in this case, the unacquired information determination unit 32 may identify, for example, a “production area of chocolate”, a “manufacturer of chocolate”, or the like as the unidentified information, in addition to the “type of chocolate”.

Moreover, when the input information that is received by the reception unit 30 is information on a character string of “thinking of eating out with YYY around Akasaka, but what kind of restaurant is good?” and when a “genre of food” is not identified, the unacquired information determination unit 32 determines the “genre of food” as the unidentified information. Furthermore, in this case, the unacquired information determination unit 32 may identify, for example, an “area of restaurant”, a “price range of restaurant”, or the like as the unidentified information, in addition to the “genre of food”.

The unacquired information determination unit 32 stores therein, for each of the services, the service type and the plurality of parameters in an associated manner, and identifies the plurality of parameters that are associated with the identified service type. The plurality of parameters include the mandatory parameter and the additional parameter, but embodiments are not limited to this example. The unacquired information determination unit 32 identifies a plurality of parameters that are associated with the service type that is identified by the service identification unit 31 from among the stored service types of the respective services and the plurality of parameters for each of the service types.

Further, the unacquired information determination unit 32 identifies, as an unidentified parameter, a mandatory parameter for which a value is not yet identified among the plurality of parameters that are associated with the service type that is identified by the service identification unit 31. Furthermore, the unacquired information determination unit 32 may identify, as an unidentified parameter, an additional parameter for which a value is not yet identified among the plurality of parameters, in addition to the mandatory parameter for which the value is not yet identified.

Moreover, when the instruction information is set such that the generative AI outputs information on a parameter for which a value is not yet identified, the unacquired information determination unit 32 may identify an unidentified parameter from among the plurality of parameters that are associated with the service type that is identified by the service identification unit 31 based on the information that is output from the generative AI.

Furthermore, the unacquired information determination unit 32 may directly determine unacquired information from the input information that is received by the reception unit 30. For example, when a service that corresponding to the service information that is provided by the providing unit 35 is identified, the unacquired information determination unit 32 may determine unacquired information by using a term list of the identified service or may cause the generative AI to determine unacquired information.

### 3.7.4.4. Target Agent Identification Unit 33

When the unacquired information determination unit 32 determines that the unacquired information is present, the target agent identification unit 33 identifies an agent that is estimated to have the unacquired information as a target agent. The agent that is estimated to have the unacquired information is an agent that is estimated to be able to provide the unacquired information.

For example, the target agent identification unit 33 identifies, as the garget agent, a service agent that is estimated to have the unacquired information by the unacquired information determination unit 32 among the plurality of service agents that provide respective services.

When, for example, the unacquired information is a profile of the user U₁, the target agent identification unit 33, estimates, as a service agent that includes the unacquired information, an agent of a profile providing service that provides the profile of the user U₁ among the plurality of service agents that provide respective services. The profile of the user U₁ includes, for example, information on an attribute of the user U₁, on the user U, or the like. In the service information apparatus 2 or the like, the service agent is arranged for each of service types, but it may be possible to arrange a single service agent for a plurality of kinds of services.

When for example, the unacquired information is a service history of the user U in a specific service, the target agent identification unit 33 estimates, as the service agent that includes the unacquired information, an agent of a specific service among the plurality of service agents that provide services. Examples of the specific service include the restaurant search service and the hotel search service, but embodiments are not limited to this example.

Furthermore, when the unacquired information is API information of a target service type, the target agent identification unit 33 estimates, as the service agent that includes the unacquired information, an agent of a service information providing service that provides API information on various kinds of services among the plurality of service agents that provide services.

For example, when the unacquired information is information on a different user U other than the user U₁, the target agent identification unit 33 identifies, as the target agent, a certain personal agent PA that is a personal agent PA of the different user U and that is estimated to have the unacquired information.

The target agent identification unit 33 identifies, as the target agent, the personal agent PA of the different user U in a chat room of a group that is set for the plurality of users U that include the user U and the different user U, for example. Here, it is assumed that the target agent identification unit 33 is the target agent identification unit 33 of the information processing terminal 1₁ of the user U₁.

Furthermore, it is assumed that the input information that is received by the reception unit 30 is information on a character string of “thinking of giving a chocolate to XXX on Valentine's Day, but what kind of chocolate does XXX like?”, and “XXX” is the user U₂.

In this case, the target agent identification unit 33 identifies the personal agent PA₂ of the user U₂ as the target agent. Furthermore, in this case, the service type that is identified by the service identification unit 31 is the “product search service” and the type of the unacquired information that is determined by the unacquired information determination unit 32 is the “type of chocolate”.

Moreover, it is assumed that the input information that is received by the reception unit 30 is information on a character string of “thinking of eating out with YYY around Akasaka, but what kind of restaurant is good?” “YYY” and “YYY” is the user Uₙ.

In this case, the target agent identification unit 33 identifies the personal agent PAₙ of the user Uₙ as the target agent. Furthermore, in this case, the service type that is identified by the service identification unit 31 is a “restaurant search service”, the parameter for which the value is identified by the service identification unit 31 is “around Akasaka”, and the type of the unacquired information that is determined by the unacquired information determination unit 32 is a “genre of food”.

Moreover, when the input information that is received by the reception unit 30 is a message that is posted in the chat room of the group A, the target agent identification unit 33 is able to identify, as target agents, the personal agents PA of the different user U₂, Uₙ or one or more the different users U in the chat room of the group A.

For example, the target agent identification unit 33 identifies, as the target agent, the personal agent PA of the user U for whom the unacquired information that is determined by the unacquired information determination unit 32 needs to be acquired among the different users U₂ and Uₙ.

For example, it is assumed that the unacquired information that is identified by the unacquired information determination unit 32 is the “genre of food”, and it is possible to identify a genre of food that is loved by the user U₂ from a chat message of the user U₂ in the chat room of the group A, but it is difficult to identify a genre of food that is loved by the user Uₙ from the chat message of the user U₂ in the chat room of the group A. In this case, the target agent identification unit 33 identifies the personal agent PAₙ of the user Uₙ as the target agent.

Meanwhile, the target agent identification unit 33 performs a process of identifying the genre of food that is loved by the user Uₙ from the chat message of the user U₂ by using, for example, the generative AI. For example, the target agent identification unit 33 may input, as the input information, information that includes a history of chat messages in the chat room of the group A and instruction information for instructing estimation of a genre of food that is loved by each of the users U from the history of chat messages to the generative AI, and output information that indicates the genre of food that is loved by each of the users U.

Furthermore, the target agent identification unit 33 may estimate the genre of food that is loved by each of the users U from the history of chat messages in the chat room of the group A by using a food genre list that is a list of words that indicate genres of food, for example.

### 3.7.4.5. Inquiry Unit 34

The inquiry unit 34 makes an inquiry to the target agent that is identified by the target agent identification unit 33 about the unacquired information. The inquiry unit 34 makes an inquiry to the target agent about the unacquired information by, for example, transmitting a message that includes information for identifying the unacquired information to the target agent. The inquiry unit 34 acquires the unacquired information that is provided by the target agent in response to the inquiry.

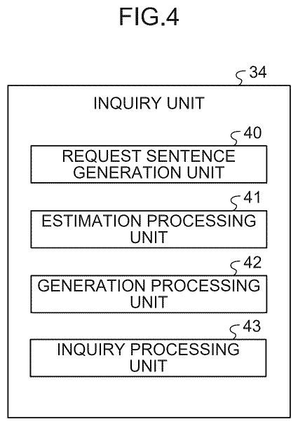

FIG. 4 is a diagram illustrating an example of a configuration of the inquiry unit 34 in the personal agent processing unit 23 of the information processing terminal 1 according to one embodiment. As illustrated in FIG. 4, the inquiry unit 34 includes a request sentence generation unit 40, an estimation processing unit 41, a generation processing unit 42, and an inquiry processing unit 43.

The request sentence generation unit 40 generates a request sentence that is a sentence for requesting the target agent that is identified by the target agent identification unit 33 to notify the unacquired information. The request sentence generation unit 40 is able to generate the request sentence by using, for example, generative AI.

For example, the request sentence generation unit 40 inputs, as input information, information that includes the type of the unacquired information and the instruction information to the generative AI, and causes the generative AI to generate the request sentence. The type of the unacquired information is, for example, a type of an unidentified parameter, but embodiments are not limited to this example. Furthermore, the instruction information is, for example, information of “Please generate a sentence for making an inquiry to an agent about given information”, but embodiments are not limited to this example.

Furthermore, the request sentence generation unit 40 may have a template of the request sentence, and generate the request sentence by adding information that indicates the type of the unacquired information to the template. Moreover, the request sentence generation unit 40 may have a template of the request sentence for each type of the unacquired information, and generate the request sentence by using the template.

The estimation processing unit 41 estimates a situation of the group in the chat room based on message histories of the plurality of users in the chat room. For example, the estimation processing unit 41 is able to estimate a situation in the chat room of the group A based on message histories of the plurality of users U₁, U₂, Uₙ in the chat room of the group A.

The situation of the group is a type of a topic in the group, a depth of the topic in the group, an atmosphere of the group, a hierarchical relationship of the plurality of users U in the group, a degree of intimacy in the group, a degree of humor, or the like, but embodiments are not limited to this example.

The estimation processing unit 41 may input, as the input information that includes the message histories of the plurality of users U in the chat room of the group A and instruction information for instructing estimation of the situation of the group in the chat room to the generative AI, and cause the generative AI to output an estimation result of the situation of the group, for example.

In this case, the instruction information is, for example, information on a character string of “Please estimate the situation of the group in the chat room of the plurality of users U from a given history of chat messages among the plurality of users U.” or the like, but embodiments are not limited to this example. The instruction information may include a situation list, exemplary information on a combination of an exemplary message history and an exemplary situation, or the like.

The generation processing unit 42 generates a message that is posted to the chat room of the group that is set for the plurality of users U that include the user U and the different user U and that is for inquiring the unacquired information.

The message that is generated by the generation processing unit 42 is a chat message that is displayed on the chat room of the group, and is a chat message that is displayed only in the chat room of the information processing terminal 1 of the user U that corresponds to the target agent that is identified by the target agent identification unit 33. Meanwhile, the chat message that is generated by the generation processing unit 42 may be displayed in chat rooms of the information processing terminals 1 of all of the users U who belong to the group.

The message that is generated by the generation processing unit 42 is the same as the request sentence that is generated by the request sentence generation unit 40, and is generated by the same process as the request sentence generation unit 40.

Furthermore, the generation processing unit 42 may generate, as a message, the message for inquiring the unacquired information based on the situation that is estimated by the estimation processing unit 41. For example, the generation processing unit 42 generates a message with a polite tone when the estimation processing unit 41 estimates that the atmosphere of the group is bad, and generates a message with a rough tone when the estimation processing unit 41 estimates that the atmosphere of the group is bad.

Moreover, the generation processing unit 42 generates a message for inquiring a genre of food that is loved when the topic of the group that is estimated by the estimation processing unit 41 is other than a topic of a specific genre of food. Furthermore, when the topic of the group that is estimated by the estimation processing unit 41 is Chinese food, the generation processing unit 42 generates a message for inquiring a genre of food among Chinese foods.

The inquiry processing unit 43, makes an inquiry to the target agent about the unacquired information by using the request sentence that is generated by the request sentence generation unit 40. The inquiry processing unit 43 makes an inquiry to the target agent about the unacquired information by transmitting information that includes the request sentence that is generated by the request sentence generation unit 40 to the target agent. The inquiry processing unit 43 acquires the unacquired information that is provided by the target agent in response to the inquiry.

Furthermore, the inquiry processing unit 43 may post the message that is generated by the generation processing unit 42 to the chat room to make an inquiry to the target agent that is identified by the target agent identification unit 33 about the unacquired information.

Meanwhile, when for example, a hidden mode that is setting of a hidden state is set, the inquiry processing unit 43 is able to notify the personal agent PA, to which the inquiry is made, that the message that is generated by the generation processing unit 42 needs to be hidden. Moreover, when, for example, a display mode that is setting of a display state is set, the inquiry processing unit 43 is able to notify the personal agent PA, to which the inquiry is made, that the message that is generated by the generation processing unit 42 needs to be displayed.

### 3.7.4.6. Providing Unit 35

The providing unit 35 provides a service to the user U by using information that is provided by the target agent in response to the inquiry that is made by the inquiry unit 34.

For example, the providing unit 35 acquires information on a service of the service type that is identified by the service identification unit 31 based on the service type that is identified by the service identification unit 31 and the information that is provided by the target agent in response to the inquiry that is made by the inquiry unit 34.

For example, the providing unit 35 transmits a service provision request that includes the service type that is identified by the service identification unit 31 and information that includes, as a value of a parameter, the information that is provided by the target agent in response to the inquiry that is made by the inquiry unit 34, to the service providing apparatus 2. Accordingly, the service providing apparatus 2 outputs information on a service that corresponds to the service provision request.

When a parameter for which a value is identified by the service identification unit 31 is present, the providing unit 35 transmits, as the service provision request, information that further includes the value of the parameter to the service providing apparatus 2. Accordingly, the providing unit 35 is able to acquire more detailed information on the service.

In this manner, the providing unit 35 acquires, for example, information on the service of the service type that is identified by the service identification unit 31 from the service providing apparatus 2, and provides the acquired information on the service to the user U. For example, the providing unit 35 causes the display unit 11 to display the information on the service that is acquired from the service providing apparatus 2, and provides the information on the service that is acquired from the service providing apparatus 2 to the user U.

For example, when the service type that is identified by the service identification unit 31 is the product search service, the providing unit 35 designates the product search service and transmits, as a service provision request, a search request that includes information indicating a type of a product as the information on the parameter to the service providing apparatus 2 via the API of the service providing apparatus 2.

The service providing apparatus 2 searches for a plurality of products in accordance with the search request, and provide a search result, as the information on the service of the service type that is identified by the service identification unit 31, to the providing unit 35. The search result includes, for example, information, such as a name, a price, evaluation, or an introduction text, of each of the retrieved products, but embodiments are not limited to this example.

For example, when the service type that is identified by the service identification unit 31 is the restaurant search service, the providing unit 35 designates the restaurant search service, and transmits, as the service provision request, a search request that includes information indicating a genre of food as the information on the parameter to the service providing apparatus 2 via the API of the service providing apparatus 2.

The service providing apparatus 2 searches for a plurality of restaurants in accordance with the search request, and provides a search result, as the information on the service of the service type that is identified by the service identification unit 31 to the providing unit 35. The search result includes, for example, information on a name, a place, evaluation, an introduction text, or the like of each of the retrieved restaurants, but embodiments are not limited to this example.

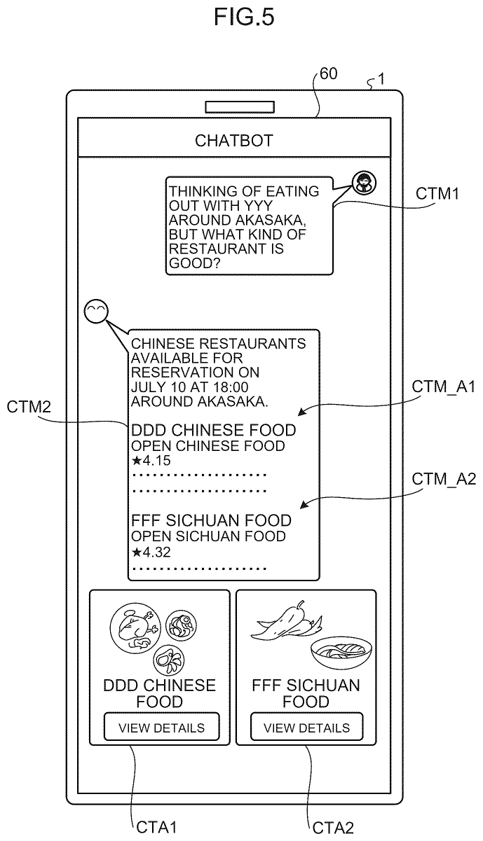

FIG. 5 is a diagram illustrating an example of a screen 60 of the chat room that is provided by the providing unit 35 in the processing unit 16 of the information processing terminal 1 according to one embodiment and that is displayed on the display unit 11. In the example illustrated in FIG. 5, in the screen 60 of the chat room, the restaurant information CTA1, the restaurant information CTA2, the restaurant information CTM_A1, and the restaurant information CTM_A2 are displayed as service information. The restaurant information CTA1 and the restaurant information CTM_A1 are pieces of information on DDD Chinese food, and the restaurant information CTA2 and the restaurant information CTM_A2 are pieces of information on FFF Sichuan food.

The restaurant information CTM_A1 and the restaurant information CTM_A2 are pieces of information in message formats, and included in the chat message CTM2. The restaurant information CTM_A1 and the restaurant information CTM_A2 are displayed in the same display mode as the display mode of the chat message in the screen of the group chat. The restaurant information CTA1 and the restaurant information CTA2 are pieces of information in a banner format that includes an image, text, and a link.

Meanwhile, the screen 60 of the chat room is a chat room of a chatbot in which the personal agent PA and the user U exchange chats, and, when the input information that is received by the reception unit 30 is a chat message of the group chat, service information is displayed in the chat room of the group chat.

### 3.7.4.7. Inquiry Response Unit 36

The inquiry response unit 36 gives an answer corresponding to the inquiry about the unacquired information. For example, the inquiry response unit 36 receives an inquiry about the unacquired information from a different personal agent PA, and provides, as the unacquired information, information corresponding to the inquiry from the different personal agent PA to the different personal agent PA.

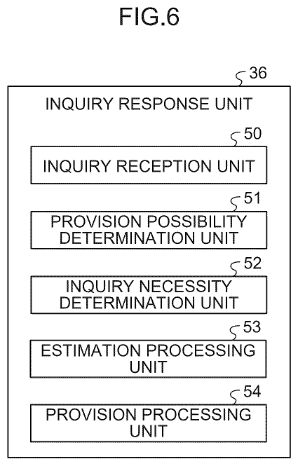

FIG. 6 is a diagram illustrating an example of a configuration of the inquiry response unit 36 in the personal agent processing unit 23 of the information processing terminal 1 according to one embodiment. As illustrated in FIG. 6, the inquiry response unit 36 includes an inquiry reception unit 50, a provision possibility determination unit 51, an inquiry necessity determination unit 52, an estimation processing unit 53, and a provision processing unit 54.

The inquiry reception unit 50 receives an inquiry about the unacquired information from the personal agent PA of a different user U.

The provision possibility determination unit 51 determines whether or not to provide unacquired information in response to the inquiry that is received by the inquiry reception unit 50. The provision possibility determination unit 51 has, for example, the provision possibility information that indicates possibility of provision for each type of unacquired information, and determines whether or not it is possible to provide the unacquired information based on the provision possibility information. The provision possibility information is set by, for example, the user U.

The provision possibility determination unit 51 determines that the unacquired information is to be provided when the provision possibility information has setting indicating that provision of the unacquired information is possible, and determines that the unacquired information is not to be provided in other cases.

The inquiry necessity determination unit 52 makes an inquiry to the user U if it is possible to provide the unacquired information in response to the inquiry that is received by the inquiry reception unit 50. The inquiry necessity determination unit 52 may have, for example, the inquiry necessity information may that indicates necessity of an inquiry to the user U for each type of the unacquired information. The inquiry necessity information is set by, for example, the user U.

When the type of the unacquired information (for example, the type of the unidentified parameter) is a certain type for which an inquiry to the user U is needed, the inquiry necessity determination unit 52 displays, in a pop-up manner, an inquiry message for inquiring if it is allowed to provide the unacquired information to the user U, in a display area of the display unit 11.

When the user U inputs positive information (for example, information on a character string of “Yes”, information on a character string of “OK”, or the like) in response to the inquiry message that is displayed in a pop-up manner, the inquiry necessity determination unit 52 outputs the unacquired information the personal agent PA that has made the inquiry.

The estimation processing unit 53 estimates a relationship between the different user U who corresponds to the personal agent PA that has made the inquiry and the user U. The relationship between the different user U and the user U is, for example, a parent-child relationship, a colleague relationship, a boss-subordinate relationship, a relationship based on hobbies, or the like. Furthermore, the relationship between the different user U and the user U may include a degree of intimacy or the like.

The estimation processing unit 53 estimates a relationship between the different user U and the user U based on, for example, the history of the chat message between the different user U and the user U.

The estimation processing unit 53 may input, as the input information, information that includes the history of the chat message between the different user U and the user U and instruction information for instructing estimation of the relationship between the different user U and the user U to the generative AI, and cause the generative AI to output an estimation result of the relationship between the different user U and the user U, for example.

In this case, the instruction information is, for example, information on a character string of “Please estimate a relationship between users from a given history of chat messages among users.” or the like, but embodiments are not limited to this example. The instruction information may include a relationship list, exemplary information on a combination of an exemplary message history and an exemplary relationship, or the like.

The provision processing unit 54 provides, to the personal agent PA, the unacquired information that is determined, by the provision possibility determination unit 51, to be provided. For example, the provision processing unit 54 acquires, from the storage unit 15 or the like, the unacquired information that is determined, by the provision possibility determination unit 51, to be provided, and provides the acquired unacquired information to the personal agent PA. Furthermore, when the user U give permission to the inquiry that is made by the inquiry necessity determination unit 52, the provision processing unit 54 provides the unacquired information to the personal agent PA.

Moreover, when the provision possibility determination unit 51 determines that the unacquired information is to be provided and when the user U gives permission to the inquiry that is made by the inquiry necessity determination unit 52, the provision processing unit 54 provides the unacquired information to the personal agent PA.

For example, when the type of the unacquired information is the type of chocolate that is loved by the user U and the user U loves bitter chocolates, the provision processing unit 54 outputs information on a character string of “bitter chocolates” or a character string of “XXX loves bitter chocolates.” as the unacquired information.

Furthermore, when, for example, the type of the unacquired information is a genre of food that is loved by the user U and the user U loves Chinese food, information on a character string of “Chinese food” or a character string of “YYY loves Chinese food.” is output as the unacquired information.

Moreover, the provision processing unit 54 provides a message that corresponds to the estimation result obtained by the estimation processing unit 53 and that includes the unacquired information to the personal agent PA that has made the inquiry. For example, the provision processing unit 54 provides the message that is generated by the generation processing unit 42 in accordance with the estimation result obtained by the provision processing unit 54 to the personal agent PA that has made the inquiry.

Furthermore, the provision processing unit 54 may make an inquiry to the user U about possibility of provision before providing the message that is generated by the generation processing unit 42 to the personal agent PA that has made the inquiry. For example, the provision processing unit 54 causes the display unit 11 to display the message that is generated by the generation processing unit 42, and makes an inquiry to the user U about the possibility of provision. When the user U gives a response indicating permission for provision, the provision processing unit 54 provides the message that is generated by the generation processing unit 42 to the personal agent PA that has made the inquiry.

For example, the inquiry about the possibility of provision of the message that is generated by the generation processing unit 42 is made by, for example, causing the display unit 11 to display information that includes information on a character string of “Is it allowed to provide following information to a terminal of YYY?” and the message that is generated by the generation processing unit 42, but embodiments are not limited to this example.

The provision processing unit 54 is able to display, in the chat room, inquiry information about the message that is generated by the generation processing unit 42, for example. In this case, the inquiry information is not displayed in a chat room of the other users U in the chat group.

The user U is give an answer to the inquiry made by the provision processing unit 54 by operating the input unit 12. For example, the user U is able to give an answer to the inquiry made by the provision processing unit 54 by inputting information on a character string of “My agent, this comment is different. I prefer ZZZ to that” (“ZZZ” is, for example, a proper name or a specific phrase of a certain category) to the information processing terminal 1.

Furthermore, the user U is able to give a response to the inquiry that is made by the provision processing unit 54 by inputting a character string of “My agent, please use subtle nuances” to the information processing terminal 1. Meanwhile, the response to the inquiry the provision processing unit 54 is not limited to the examples as described above.

The provision processing unit 54 causes the generation processing unit 42 to re-generate a message based on the response from the user U. For example, the provision processing unit 54 outputs a re-generation instruction to the generation processing unit 42, and causes the generation processing unit 42 to re-generate a message. the provision processing unit 54 may make an inquiry to the user U about possibility of provision before providing the message that is re-generated by the generation processing unit 42 to the personal agent PA that has made the inquiry, through the same process as described above.

Moreover, when there is nothing wrong with the inquiry information from the provision processing unit 54, the user U is able to give a response to the inquiry that is made by the provision processing unit 54 by inputting information on a character string of “Yes” or information that indicates a positive response, such as information on a character string of “OK”, to the information processing terminal 1. When the user U gives a positive response, the provision processing unit 54 provides the message that is generated by the generation processing unit 42 to the personal agent PA that has made the inquiry.

### 4. Flow of Processes

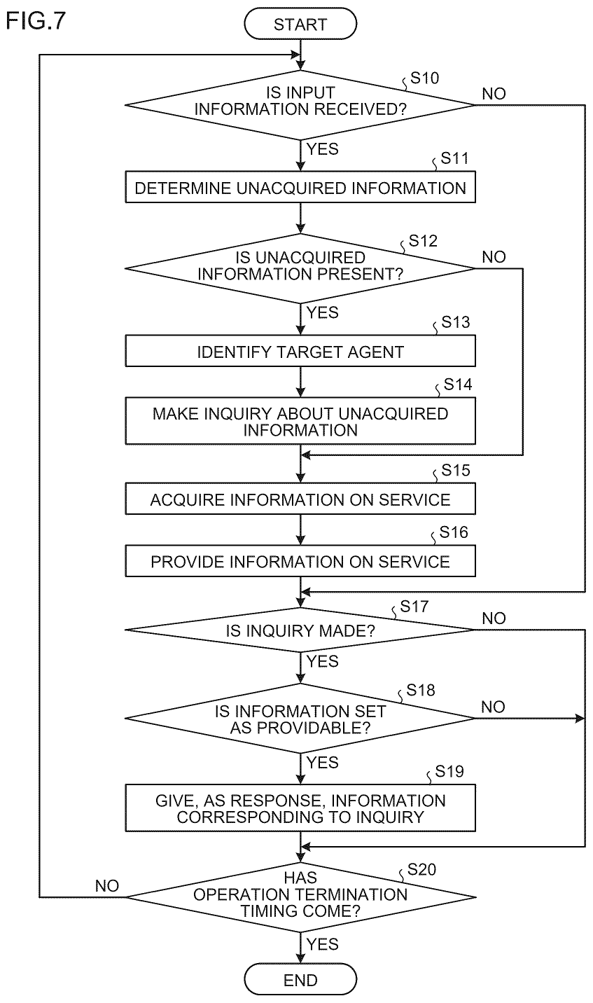

A flow of information processing that is performed by the processing unit 16 of the information processing terminal 1 according to one embodiment will be described below. FIG. 7 is a flowchart illustrating an example of the information processing that is performed by the personal agent processing unit 23 of the processing unit 16 of the information processing terminal 1 according to one embodiment.

As illustrated in FIG. 7, the personal agent processing unit 23 in the processing unit 16 of the information processing terminal 1 determines whether or not input information is received (Step S10). When it is determined that the input information is received (Step S10: Yes), the personal agent processing unit 23 determines the unacquired information based on the received input information (Step S11).

Subsequently, the personal agent processing unit 23 determines whether or not the unacquired information is present (Step S12). When it is determined that the unacquired information (Step S12: Yes), the personal agent processing unit 23 identifies a target agent (Step S13). Further, the personal agent processing unit 23 makes an inquiry to the target agent that is identified by Step S13 about the unacquired information (Step S14).

When the process at Step S14 is terminated or when it is determined that the unacquired information is not present (Step S12: No), the personal agent processing unit 23 acquires information on a service from the service providing apparatus 2 or the like (Step S15), and provides the information on the service to the user U (Step S16).

When the process at Step S16 is terminated or when it is determined that the input information is not received (Step S10: No), the personal agent processing unit 23 determines whether or not an inquiry about the unacquired information is made by the different personal agent PA (Step S17). When it is determined that the inquiry is made (Step S17: Yes), the personal agent processing unit 23 determines whether or the unacquired information that is a subject of the inquiry is set as providable (Step S18).

When it is determined that the unacquired information that is a subject of the inquiry is set as providable (Step S18: Yes), the personal agent processing unit 23 outputs information corresponding to the inquiry to the personal agent PA that has made the inquiry (Step S19).

When the process at Step S19 is terminated, when the inquiry is not made (Step S17: No), or when it is determined that the unacquired information that is a subject of the inquiry is not set as providable (Step S18: No), the personal agent processing unit 23 determines whether or not an operation termination timing has come (Step S20). The personal agent processing unit 23 determines that the operation termination timing has come when, for example, a power supply of the information processing terminal 1 is turned off.

When the personal agent processing unit 23 determines that the operation termination timing has not yet come (Step S20: No), the process goes to Step S10, and when the personal agent processing unit 23 determines that the operation termination timing has come (Step S20: Yes), the process illustrated in FIG. 7 is terminated.

### 5. Modifications

A part or all of the functions of the information processing terminal 1 as described above may be implemented by the service providing apparatus 2. For example, the service providing apparatus 2 may be configured to include a part or whole of the personal agent processing unit 23 as described above, instead of the information processing terminal 1.

In the example as described above, explanation is given based on the assumption that the generative AI is text generative AI; however, embodiments are not limited to this example, and the generative AI may be, for example, multimodal generative AI or the like. The multimodal generative AI is generative AI that is able to generate text or an image from a text, an image, or the like, for example.

Furthermore, in the example as described above, the inquiry unit 34 makes an inquiry to the target agent that is identified by the target agent identification unit 33 about the unacquired information, but it is sufficient if it is possible to make an inquiry to a target agent that is identified by the target agent identification unit about the unacquired information, and it is possible to make an inquiry to the target agent about the unacquired information via a different agent or a different apparatus.

Moreover, in the example as described above, the inquiry unit 34 acquires the unacquired information that is provided by the target agent in response to the inquiry; however, embodiments are not limited to this example, and, for example, the target agent may request a different agent or a different apparatus to provide the unacquired information and acquire the unacquired information that is provided by the different agent or the different apparatus. The providing unit 35 provides a service to the user U by using the unacquired information that is obtained in response to the inquiry that is made by the inquiry unit 34.

### 6. Hardware Configuration

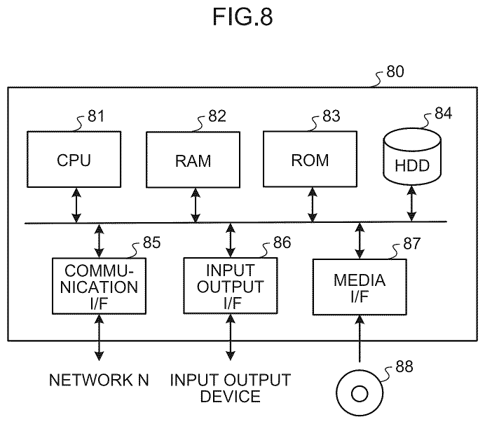

The information processing terminal 1 according to one embodiment as described above is implemented by, for example, a computer 80 that has a configuration as illustrated in FIG. 8. FIG. 8 is a diagram illustrating an example of a hardware configuration of the computer 80 that implements the functions of the information processing terminal 1 according to one embodiment. The computer 80 includes a CPU 81, a RAM 82, a Read Only Memory (ROM) 83, a Hard Disk Drive (HDD) 84, a communication interface (I/F) 85, an input output interface (I/F) 86, and a media interface (I/F) 87.

The CPU 81 operates based on a program that is stored in the ROM 83 or the HDD 84, and controls each of the units. The ROM 83 stores therein a boot program that is executed by the CPU 81 at the time of activation of the computer 80, a program that is dependent on hardware of the computer 80, and the like.

The HDD 84 stores therein a program that is executed by the CPU 81, data that is used by the program, and the like. The communication interface 85 receives data from a different apparatus via the network N (see FIG. 2), sends the data to the CPU 81, and transmits data that is generated by the CPU 81 to a different apparatus via the network N.

The CPU 81 controls an output device, such as a display and a printer, and an input device, such as a keyboard or a mouse, via the input output interface 86. The CPU 81 acquires data from the input device via the input output interface 86. Further, the CPU 81 outputs generated data to the output device via the input output interface 86.

The media interface 87 reads a program or data that is stored in a recording medium 88, and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 80 functions as the information processing terminal 1 according to one embodiment, the CPU 81 of the computer 80 executes a program that is loaded on the RAM 82 and implements the functions of the processing unit 16. Further, the HDD 84 stores therein data in the storage unit 15. The CPU 81 of the computer 80 reads the programs from the recording medium 88 and executes the programs; however, as another example, it may be possible to acquire the programs from a different apparatus via the network N.

### 7. Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the information processing terminal 1 as described above may be implemented by a terminal apparatus and a server computer, may be implemented by a plurality of server computers, or may be implemented by calling an external platform or the like for some of the functions via an API, network computing, or the like, and the configuration may be flexibly changed.

Furthermore, the embodiments and the modifications as described above may be appropriately combined as long as processing contents do not conflict with each other.

### 8. Effects

As described above, the information processing terminal 1 according to one embodiment is one example of an information processing apparatus and includes the unacquired information determination unit 32, the target agent identification unit 33, the inquiry unit 34, and the providing unit 22. The unacquired information determination unit 32 that determines whether unacquired information is present among pieces of information that are used to provide a service to the user U. The target agent identification unit 33, when the unacquired information determination unit 32 determines that the unacquired information is present, identifies an agent that is estimated to have the unacquired information as a target agent. The inquiry unit 34 makes an inquiry to the target agent that is identified by the target agent identification unit 33 about the unacquired information. The providing unit 35 provides the service to the user U by using information that is obtained in response to the inquiry that is made by the inquiry unit 34. With this configuration, the information processing terminal 1 is able to appropriately acquires information on the user U and provide a service.

Furthermore, the target agent identification unit 33 identifies, as the target agent, a service agent that is estimated to have the unacquired information among a plurality of service agents that provide respective services. With this configuration, the information processing terminal 1 is able to appropriately acquires information on the user U and provide a service.

Moreover, the target agent identification unit 33 identifies, as the target agent, a personal agent PA that is a personal agent PA of a different user U and that is estimated to have the unacquired information. With this configuration, the information processing terminal 1 is able to appropriately acquires information on the user U and provide a service.

Furthermore, the information processing terminal 1 further includes the reception unit 30 that receives input information from the user U, and the service identification unit 31 that identifies a type of the service based on the input information that is received by the reception unit 30. The unacquired information determination unit 32 identifies, as the unacquired information, information on a parameter for which a value is not yet identified among parameters that are used to provide a service of the identified type identified by the service identification unit 31. With this configuration, the information processing terminal 1 is able to more appropriately acquire information on the user U and provide a service.

Moreover, the service identification unit 31 input, to generative AI, information that includes the input information that is received by the reception unit 30 and a type of the service, and identifies a type of the service based on information that indicates a type of the service that is identified by the generative AI. With this configuration, the information processing terminal 1 is able to appropriately acquires information on the user U and provide a service.

Furthermore, the inquiry unit 34 includes the request sentence generation unit 40 that generates a request sentence that is a sentence for requesting the target agent that is identified by the target agent identification unit 33 to notify the unacquired information, and the inquiry processing unit 43 that inquires the unacquired information by using the request sentence that is generated by the request sentence generation unit 40. With this configuration, the information processing terminal 1 is able to more appropriately acquire information on the user U and provide a service.

Moreover, the information processing terminal 1 further includes the inquiry reception unit 50 that receives an inquiry about the unacquired information from the personal agent PA, the provision possibility determination unit 51 that determines whether to provide the unacquired information in response to the inquiry that is received by the inquiry reception unit 50, and the provision processing unit 54 that provides, to the personal agent, the unacquired information that is determined to be provided by the provision possibility determination unit 51. With this configuration, the information processing terminal 1 is able to more appropriately acquire information on the user U and provide a service.

Furthermore, the target agent identification unit 33 identifies, as a target agent, a personal agent PA of the different user U in a chat room of a group that is set for a plurality of users U including the user U and the different user U. With this configuration, the information processing terminal 1 is able to more appropriately acquire information on the user U and provide a service.

Moreover, the inquiry unit 34 includes the generation processing unit 42 that generates a message that is to be posted in a chat room of a group that is set for a plurality of users U including the user U and the different user U and that is a message for inquiring the unacquired information, and the inquiry processing unit 43 that posts the message that is generated by the generation processing unit 42 to the chat room and makes an inquiry to the target agent that is identified by the target agent identification unit 33 about the unacquired information. With this configuration, the information processing terminal 1 is able to more appropriately acquire information on the user U and provide a service.

Furthermore, the inquiry unit 34 includes the estimation processing unit 41 that estimates a situation of the group in the chat room based on a message history of the plurality of users U in the chat room, and the generation processing unit 42 generates the message for inquiring the unacquired information based on the situation that is estimated by the estimation processing unit 41. With this configuration, the information processing terminal 1 is able to more appropriately acquire information on the user U and provide a service.

Moreover, the information processing terminal 1 further includes the estimation processing unit 53 that estimates a relationship between the user U and the different user U, and the provision processing unit 54 provides a message that corresponds to an estimation result obtained by the estimation processing unit 53 and that includes the unacquired information to the personal agent. With this configuration, the information processing terminal 1 is able to more appropriately acquire information on the user U and provide a service.

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

In addition, the “unit (section, module, unit)” described above may be replaced with a “means”, a “circuit”, or the like. For example, the acquisition unit may be replaced with an acquisition means or an acquisition circuit.

According to one aspect of embodiments, it is possible to appropriately acquire information on a user and provide a service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an unacquired information determination unit that determines whether unacquired information is present among pieces of information that are used to provide a service to a user;
a target agent identification unit that identifies, when the unacquired information determination unit determines that the unacquired information is present, an agent that is estimated to have the unacquired information as a target agent;
an inquiry unit that makes an inquiry to the target agent that is identified by the target agent identification unit about the unacquired information; and
a providing unit that provides the service to the user by using information that is obtained in response to the inquiry that is made by the inquiry unit.

2. The information processing apparatus according to claim 1, wherein the target agent identification unit identifies, as the target agent, a service agent that is estimated to have the unacquired information among a plurality of service agents that provide respective services.

3. The information processing apparatus according to claim 1, wherein the target agent identification unit identifies, as the target agent, a personal agent that is a personal agent of a different user and that is estimated to have the unacquired information.

4. The information processing apparatus according to claim 1, further comprising:
a reception unit that receives input information from a user; and
a service identification unit that identifies a type of the service based on the input information that is received by the reception unit, wherein
the unacquired information determination unit identifies, as the unacquired information, information on a parameter for which a value is not yet identified among parameters that are used to provide a service of the identified type.

5. The information processing apparatus according to claim 4, wherein
the service identification unit inputs, to generative AI, information that includes the input information that is received by the reception unit and information indicating identification of a type of the service, and identifies a type of the service based on information that indicates a type of the service that is identified by the generative AI.

6. The information processing apparatus according to claim 1, wherein
the inquiry unit includes
a request sentence generation unit that generates a request sentence that is a sentence for requesting the target agent that is identified by the target agent identification unit to notify the unacquired information; and
an inquiry processing unit that inquires the unacquired information by using the request sentence that is generated by the request sentence generation unit.

7. The information processing apparatus according to claim 3, further comprising:
an inquiry reception unit that receives an inquiry about the unacquired information from the personal agent;
a provision possibility determination unit that determines whether to provide the unacquired information in response to the inquiry that is received by the inquiry reception unit; and
a provision processing unit that provides, to the personal agent, the unacquired information that is determined to be provided by the provision possibility determination unit.

8. The information processing apparatus according to claim 3, wherein the target agent identification unit identifies, as a target agent, a personal agent of the different user in a chat room of a group that is set for a plurality of users including the user and the different user.

9. The information processing apparatus according to claim 8, wherein
the inquiry unit includes
a generation processing unit that generates a message, the message being be posted in a chat room of a group that is set for a plurality of users including the user and the different user and being a message for inquiring the unacquired information; and
an inquiry processing unit that posts the message that is generated by the generation processing unit to the chat room and makes an inquiry to the target agent that is identified by the target agent identification unit about the unacquired information.

10. The information processing apparatus according to claim 9, wherein
the inquiry unit includes
an estimation processing unit that estimates a situation of the group in the chat room based on a message history of the plurality of users in the chat room, and
the generation processing unit generates the message for inquiring the unacquired information based on the situation that is estimated by the estimation processing unit.

11. The information processing apparatus according to claim 7, further comprising:
an estimation processing unit that estimates a relationship between the user and the different user, wherein
the provision processing unit provides a message that corresponds to an estimation result obtained by the estimation processing unit and that includes the unacquired information to the personal agent.

12. An information processing method implemented by a computer, the information processing method comprising:
determining whether unacquired information is present among pieces of information that are used to provide a service to a user;
identifying, when it is determined that the unacquired information is present at the determining, an agent that is estimated to have the unacquired information as a target agent;
making an inquiry to the target agent that is identified at the identifying about the unacquired information; and
providing the service to the user by using information that is obtained in response to the inquiry that is made at the making the inquiry.

13. A non-transitory computer readable storage medium having stored therein an information processing program that causes a computer to execute a process, the process comprising:
determining whether unacquired information is present among pieces of information that are used to provide a service to a user;
identifying, when it is determined that the unacquired information is present at the determining, an agent that is estimated to have the unacquired information as a target agent;
making an inquiry to the target agent that is identified at the identifying about the unacquired information; and
providing the service to the user by using information that is obtained in response to the inquiry that is made at the making the inquiry.
